(19) United States
(12) Patent Application Publication
(10) Pub. No.: US 2025/0179361 A1
(43) Pub. Date: Jun. 5, 2025

(54) CORROSION INHIBITING PUTTY AND METHOD

(71) Applicants: Rachel Cusic, Hollywood, MD (US); Zachary Nega, Huntingtown, MD (US); Ryan Songy, Caifornia, MD (US)

(72) Inventors: Rachel Cusic, Hollywood, MD (US); Zachary Nega, Huntingtown, MD (US); Ryan Songy, Caifornia, MD (US)

(21) Appl. No.: 18/526,426

(22) Filed: Dec. 1, 2023

(51) Int. Cl. C09K 15/06

(52) U.S. Cl. CPC C09K 15/06

(57) ABSTRACT

A corrosion inhibiting putty including clay, linseed oil, a binder and an inhibitor, wherein the clay is about 72% to about 81% weight of the putty, the linseed oil is about 1% to about 11% weight of the putty, the binder is about 1% to about 8% weight of the putty, and the inhibitor is about 4% to about 15% weight of the putty.

### STATEMENT OF GOVERNMENT INTEREST

The invention described herein may be manufactured and used by or for the Government of the United States of America for governmental purposes without payment of any royalties thereon or therefor.

### BACKGROUND

Current compounds that are used for corrosion protection fall into two classes: curing and non-curing. Curing compounds most commonly utilize sealants and adhesives. These products strongly adhere to surfaces, they are hazardous in their uncured state, have a small application time-frame, require long cure times, and must be precisely mixed. Non-curing compounds can vary from grease-like consistencies to paste-like materials. While these compounds do not have an application or curing time, the range where the products can be applied is limited by temperature and intended system environment. Both curing and non-curing compounds require a significant effort for application and removal due to the application methodology and compound physical properties.

The products currently on the market prevent corrosion but are not able to be formed or are clay-based but contain no corrosion-inhibiting compounds. Furthermore, many of these products contain various chemicals that have negative impacts on health and on the environment, and many chemicals known as major corrosion inhibitors (i.e., chromated products) are being banned.

### SUMMARY

The present invention is directed to a corrosion inhibiting putty and method with the needs enumerated above and below.

The present invention is directed to a corrosion inhibiting putty that includes clay, linseed oil, a binder, and an inhibitor. The clay is about 72% to about 81% weight of the putty, the linseed oil is about 1% to about 11% weight of the putty, the binder is about 1% to about 8% weight of the putty, and the inhibitor is about 4% to about 15% weight of the putty.

The present invention is directed to a method for making a corrosion inhibiting putty which comprises of the steps of warming clay by molding the clay in hands, breaking the clay into pieces, adding linseed oil to the clay and mixing the linseed oil into the clay, adding a binder and an inhibitor to the mixed linseed oil and clay, and mixing the binder, the inhibitor, the linseed oil, and the clay until homogenous.

The present invention is directed to a corrosion inhibiting putty of a natural, clay-based material imbedded with chrome-free corrosion inhibitors.

It is a feature of the present invention to provide a corrosion inhibiting putty that is moldable and can be shaped or formed around various geometries for corrosion protection.

It is a feature of the present invention to provide a corrosion inhibiting putty that offers the benefits of a non-curing compound while also broadening the application environment that cured compounds can tackle.

It is a feature of the present invention to provide a corrosion inhibiting putty that does not have a complex application methodology and can easily be cleaned from surfaces it is applied to. In addition, this invention does not require any preparation prior to use, removing the need for precise mixing procedures or any specialized tooling.

It is a feature of the present invention to provide a corrosion inhibiting putty wherein the formulations are chromate free, effective on mixed metal assemblies, moldable, work in an elevated temperature, reduce HAZMAT, and allow for easier cleanup.

It is a feature of the present invention to provide a corrosion inhibiting putty that contains no chemicals currently banned. In addition, many of the chemicals used in this putty are natural and/or have no harmful risks to human health or the environment.

It is a feature of the present invention to provide a corrosion inhibiting putty that has superior corrosion resistance in galvanic corrosion assemblies compared to currently available non-curing compounds.

### DESCRIPTION

The preferred embodiments of the present invention are illustrated by way of example below. The corrosion inhibiting putty has a formulation that includes clay, linseed oil, a binder, and an inhibitor. The clay is about 72% to about 81% weight of the putty, the linseed oil is about 1% to about 11% weight of the putty, the binder is about 1% to about 8% weight of the putty, and the inhibitor is about 4% to about 15% weight of the putty.

The preferred clay is plastalina modeling clay. In an alternative embodiment, the clay may be about 60% to about 81% by weight, the linseed Oil may be about 1% to about 15% by weight, the binder may be about 1% to about 15% by weight, and the inhibitor may be about 4% to about 25% by weight.

The preferred binders are selected from the group consisting of carbon carbonate and talc powder. The preferred inhibitors are selected from the group consisting of black pepper oil, yttrium oxalate, zinc oxalate, lithium phosphate, and zinc citrate.

The preferred formulation of the corrosion inhibiting putty is the clay is about 76.5% weight of the putty, the linseed oil is about 9.3% weight of the putty, the binder is talcum powder at about 1.1% weight of the putty, and the inhibitor is black pepper oiler at about 13.1% weight of the putty. Testing has shown that the preferred formulation has superior results over other corrosion inhibitors.

Any corrosion inhibiting greases, greases, non-curing corrosion inhibiting putties, and curing sealants that are practicable can be used.

A method for creating a corrosion inhibiting putty includes warming clay by molding the clay in hands, breaking the clay into pieces, adding linseed oil to the clay and mixing the linseed oil into the clay, adding a binder and an inhibitor to the mixed linseed oil and clay, and mixing the binder, the inhibitor, the linseed oil, and the clay until homogenous. An alternative method for creating the putty is warming the clay in hands and break apart, mixing linseed oil, binder, and inhibitor to form a slurry, and adding the clay to the slurry and mix.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A corrosion inhibiting putty comprising:
clay, wherein the clay is about 72% to about 81% weight of the putty;
linseed oil, wherein the linseed oil is about 1% to about 11% weight of the putty;
a binder, wherein the binder is about 1% to about 8% weight of the putty; and,
an inhibitor, wherein the inhibitor is about 4% to about 15% weight of the putty.

2. The corrosion inhibiting putty of claim 1, wherein the binder is a binder selected from the group consisting of carbon carbonate and talc powder.

3. The corrosion inhibiting putty of claim 1, wherein the inhibitor is an inhibitor selected from the group consisting of black pepper oil, yttrium oxalate, zinc oxalate, lithium phosphate and zinc citrate.

4. A method for creating a corrosion inhibiting putty, the steps comprising:
warming clay by molding the clay in hands;
breaking the clay into pieces;
adding linseed oil to the clay and mixing the linseed oil into the clay;
adding a binder and an inhibitor to the mixed linseed oil and clay;
mixing the binder, the inhibitor, the linseed oil, and the clay until homogenous.

5. The method of claim 4, wherein the clay is about 72% to about 81% weight of the putty, the linseed oil is about 1% to about 11% weight of the putty, the binder is about 1% to 8% weight of the putty, and inhibitor is about 4% to 15% weight of the putty.
